(19) United States
(12) Patent Application Publication
(10) Pub. No.: US 2026/0196853 A1
(43) Pub. Date: Jul. 9, 2026

(54) POWER STORAGE SYSTEM

(71) Applicant: MOBILETRON ELECTRONICS CO., LTD., Taichung City (TW)

(72) Inventor: WEN-CHUAN HUNG, Taichung City (TW)

(73) Assignee: MOBILETRON ELECTRONICS CO., LTD., Taichung City (TW)

(21) Appl. No.: 19/432,902

(22) Filed: Dec. 24, 2025

(30) Foreign Application Priority Data
Jan. 7, 2025 (TW) 114100542

(51) Int. Cl. H02J 7/54; H01M 10/42; H01M 10/44; H01M 10/48; H02J 7/34; H02J 7/96

(52) U.S. Cl. CPC H02J 7/54; H01M 10/425; H01M 10/441; H01M 10/482; H02J 7/342; H02J 7/96; H01M 2010/4271; H02J 2207/20

(57) ABSTRACT

A power storage system includes several battery packs, several switch units, a battery unit, and a control device electrically connected to the battery packs. Each of the switch units is controllable to conduct or block an electrical connection between an input port and an output port of each of the switch units. The input ports are electrically connected to several power output ports of the battery packs. The battery unit is electrically connected to the output ports. The control device obtains a first voltage of each of the battery packs. When the control device determines that at least one of the first voltages is greater than a first predetermined voltage, the at least one battery pack is defined as at least one target battery pack. The control device controls the at least one switch unit corresponding to the at least one target battery pack to be turned on.

### BACKGROUND OF THE INVENTION

### Technical Field

The present invention relates generally to a power storage system, and more particularly to a power storage system with a plurality of battery packs.

### Description of Related Art

With the advancement of the technology, an electricity demand greatly increases. To satisfy the great electricity demand, a power storage system has become one of the important power sources. The power storage system includes a plurality of battery packs, wherein the battery packs are connected in series/parallel to supply power, thereby raising a total capacity of the power storage system.

However, because of a power difference among the battery packs (i.e., battery imbalance), one of the battery packs with the greatest power tends to become fully charged and another one of the battery packs with the least power fails to be fully charged when the battery packs of the power storage system are charged. In addition, when the battery packs of the power storage system are discharged, one of the battery packs with the greatest power tends to become fully discharged and the another one of the battery packs with the least power fails to be fully discharged. Therefore, a total power of the power storage system could not be effectively utilized, thereby reducing a utilization efficiency of the power storage system and even reducing a useful life of the power storage system under long-term use.

Therefore, a conventional power storage system still has room for improvement. How to raise a utilization efficiency of the power storage system is one of the technical issues in the art.

### BRIEF SUMMARY OF THE INVENTION

In view of the above, the primary objective of the present invention is to provide a power storage system, which includes a plurality of battery packs. When the battery packs are balanced, at least one of the battery packs with a relatively high power could be effectively utilized.

The present invention provides a power storage system including a plurality of battery packs, a plurality of switch units, a battery unit, and a control device, wherein each of the battery packs has a power output port. Each of the switch units has an input port and an output port. Each of the switch units is controllable to conduct or block an electrical connection between each of the input ports and each of the output ports. The input port of each of the switch units is electrically connected to the power output port of each of the battery packs. The battery unit is electrically connected to the output ports of the switch units. The control device is electrically connected to the battery packs and obtains a first voltage of each of the battery packs from each of the battery packs. When the control device determines that the first voltage of at least one of the battery packs is greater than a first predetermined voltage, the at least one of the battery packs is defined as at least one target battery pack and the control device controls at least one of the switch units corresponding to the at least one target battery pack to be turned on. Until the first voltage of the at least one target battery pack is less than or equal to the first predetermined voltage, the control device controls the at least one of the switch units corresponding to the at least one target battery pack to be turned off.

With the aforementioned design, through the control device controlling the at least one of the switch units corresponding to the at least one target battery pack to be turned on when the control device determining that the first voltage of the at least one of the battery packs is greater than the first predetermined voltage, a relatively high power of the at least one target battery pack could be transmitted to the battery unit to charge the battery unit, so that the first voltage of the at least one target battery pack could be less than or equal to the first predetermined voltage. Therefore, the first voltages of the battery packs could be similar or identical, i.e., battery balancing, thereby raising a utilization efficiency of the power storage system and raising a useful life of the power storage system.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a schematic view of the power storage system according to a first embodiment of the present invention;

FIG. 2 is a schematic view of the power storage system according to a second embodiment of the present invention;

FIG. 3 is a schematic view of the power storage system according to a third embodiment of the present invention;

FIG. 4 is a schematic view of the power storage system according to a fourth embodiment of the present invention;

FIG. 5 is a schematic view of the power storage system according to a fifth embodiment of the present invention;

FIG. 6 is a schematic view of the power storage system according to a sixth embodiment of the present invention; and

FIG. 7 is a schematic view of the power storage system according to a seventh embodiment of the present invention.

### DETAILED DESCRIPTION OF THE INVENTION

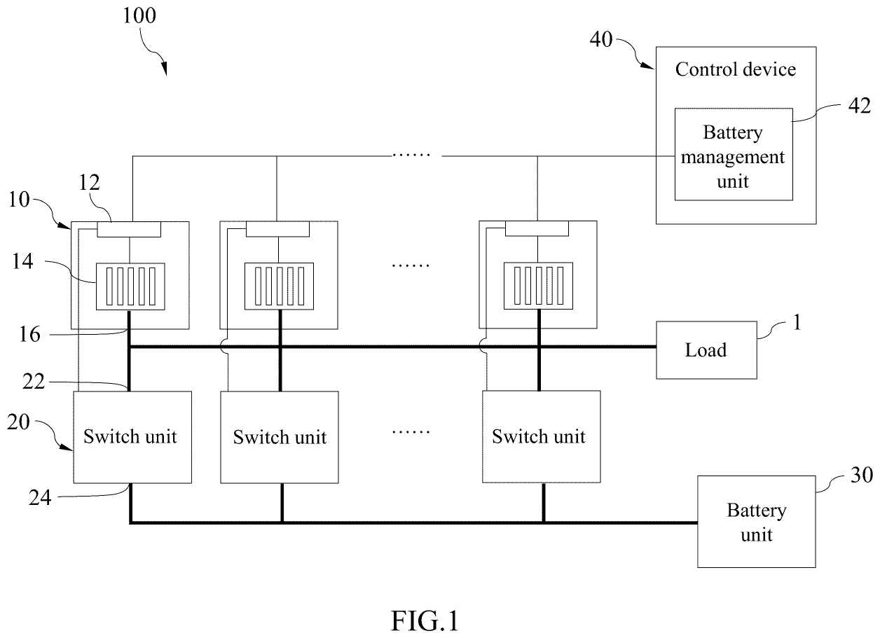

A power storage system 100 according to a first embodiment of the present invention is illustrated in FIG. 1 and is adapted to supply power to a load 1. The power storage system 100 includes a plurality of battery packs 10, a plurality of switch units 20, a battery unit 30, and a control device 40. In the current embodiment, the load 1 is a motor of an electric vehicle, but not limited thereto.

Each of the battery packs 10 includes a cell monitor unit 12 and a battery cell module 14, wherein each of the cell monitor units 12 is electrically connected to each of the battery cell modules 14. Each of the battery cell modules 14 has a first voltage. Each of the battery packs 10 has a power output port 16, wherein each of the power output ports 16 is electrically connected to each of the battery cell modules 14 and the load 1.

Each of the switch units 20 is electrically connected to the cell monitor unit 12 of each of the battery packs 10 and has an input port 22 and an output port 24, wherein the input port 22 of each of the switch units 20 is electrically connected to the power output port 16 of each of the battery packs 10. Each of the cell monitor units 12 controls each of the switch units 20 to conduct or block an electrical connection between each of the input ports 22 and each of the output ports 24. For example, each of the switch units 20 could include a transistor or a plurality of transistors electrically connected to each of the input ports 22 and each of the output ports 24 and being controllable to conduct or block the electrical connection between each of the input ports 22 and each of the output ports 24.

The battery unit 30 is electrically connected to the output ports 24 of the switch units 20. In the current embodiment, the battery unit 30 is adapted to supply power to a low-voltage system of the electric vehicle, and a rated voltage of the battery unit 30 is identical to a rated voltage of each of the battery packs 10. For example, the rated voltage of the battery unit 30 is 24 V or 12 V, and the rated voltage of each of the battery packs 10 is 24 V or 12 V, but not limited thereto. In the current embodiment, the battery unit 30 could be a lead-acid battery or a lithium battery as an example, but not limited thereto.

The control device 40 includes a battery management unit 42, wherein the battery management unit 42 is electrically connected to the cell monitor units 12 of the battery packs 10. The battery management unit 42 obtains the first voltage of each of the battery cell module 14 through each of the cell monitor units 12 to determine if the first voltage of at least one of the battery packs 10 is greater than a first predetermined voltage. In the current embodiment, the first predetermined voltage could be the rated voltage of each of the battery packs 10 plus 2 V as an example. For example, the rated voltage of each of the battery packs 10 is 24 V, and the first predetermined voltage is 26 V.

When the battery management unit 42 determines that the first voltage of one of the battery packs 10 is greater than the first predetermined voltage, the corresponding battery pack 10 is defined as a target battery pack. The battery management unit 42 transmits a conducting control signal to the cell monitor unit 12 of the target battery pack. The cell monitor unit 12 of the target battery pack controls one of the switch units 20 corresponding to the target battery pack to be turned on according to the conducting control signal, so that the target battery pack outputs the first voltage to the battery unit 30 through the power output port 16 of the target battery pack and one of the switch units 20 corresponding to the target battery pack. Until the first voltage of the target battery pack is less than or equal to the first predetermined voltage, the battery management unit 42 transmits a blocking control signal to the cell monitor unit 12 of the target battery pack. The cell monitor unit 12 of the target battery pack controls one of the switch units 20 corresponding to the target battery pack to be turned off according to the blocking control signal. Therefore, the first voltages of the battery packs 10 are similar or identical, thereby achieving a passive balancing. At the same time, a relatively high power of the target battery pack could be utilized to charge the battery unit 30, thereby effectively utilizing a power of the power storage system 100.

In addition, when the battery management unit 42 determines that the first voltage of each of the battery packs 10 is greater than the first predetermined voltage, each of the corresponding battery packs 10 is defined as the target battery pack. The battery management unit 42 transmits the conducting control signals to the cell monitor units 12 of the target battery packs. The cell monitor unit 12 of each of the target battery packs controls each of the switch units 20 corresponding to each of the target battery packs to be turned on according to each of the conducting control signals. For example, a number of the target battery packs is two, and the battery management unit 42 transmits the blocking control signal to the cell monitor unit 12 of one of the two target battery packs when the first voltage of one of the two target battery packs is less than or equal to the first predetermined voltage. After the cell monitor unit 12 of one of the two target battery packs controls one of the switch units 20 corresponding to one of the two target battery packs to be turned off according to the blocking control signal, the battery management unit 42 transmits the conducting control signal to the cell monitor unit 12 of the other target battery pack. The cell monitor unit 12 of the other target battery pack controls another one of the switch units 20 corresponding to the other target battery pack to be turned on according to the conducting control signal. Therefore, the first voltages of the battery packs 10 could also be similar or identical and could be utilized to charge the battery unit 30, thereby achieving the passive balancing and effectively utilizing the power of the power storage system 100. In the current embodiment, the battery management unit 42 transmits each of the conducting control signals and each of the blocking control signals to the cell monitor unit 12 of each of the target battery packs in a descending order of the first voltages of the target battery packs. The cell monitor unit 12 of each of the target battery packs controls each of the corresponding switch unit 20 to be turned on or be turned off according to each of the conducting control signals and each of the blocking control signals in the descending order of the first voltages of the target battery packs.

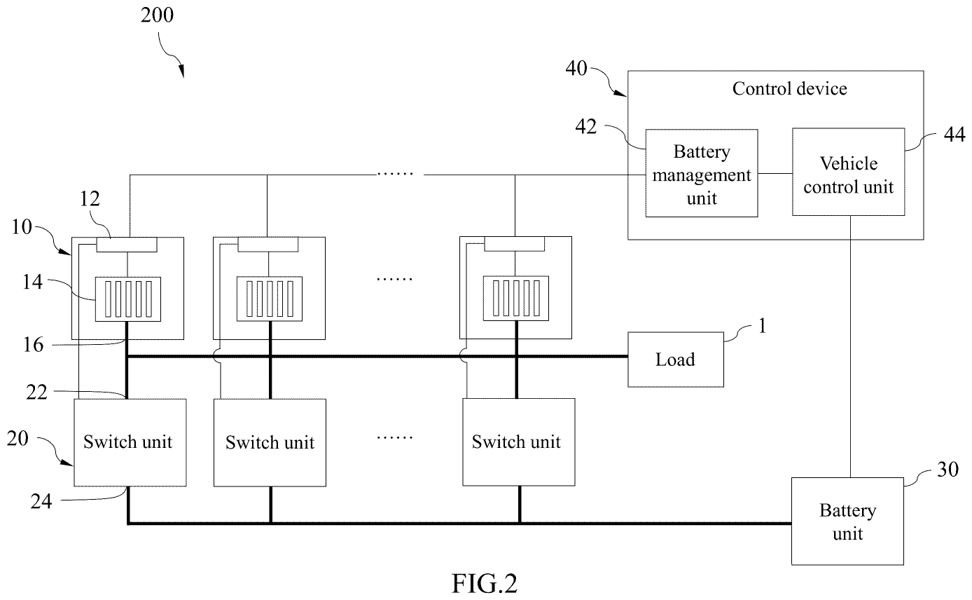

A power storage system 200 according to a second embodiment of the present invention is illustrated in FIG. 2. A structure of the power storage system 200 is almost identical to a structure of the power storage system 100, except that the control device 40 includes a vehicle control unit 44. The vehicle control unit 44 is electrically connected to the battery unit 30 and the battery management unit 42. The battery unit 30 has a second voltage. The vehicle control unit 44 is adapted to obtain the second voltage and transmit the second voltage to the battery management unit 42. The battery management unit 42 is adapted to determine if the second voltage of the battery unit 30 is less than a second predetermined voltage. In the current embodiment, the second predetermined voltage could be the rated voltage of the battery unit 30 as an example.

When the battery management unit 42 of the control device 40 determines that the first voltage of the at least one of the battery packs 10 is greater than the first predetermined voltage and the second voltage of the battery unit 30 is less than the second predetermined voltage, the battery management unit 42 transmits the at least one conducting control signal to the cell monitor unit 12 of the at least one target battery pack. The cell monitor unit 12 of the at least one target battery pack controls at least one of the switch units 20 corresponding to the at least one target battery pack to be turned on according to the at least one conducting control signal, so that the at least one target battery pack outputs the first voltage to the battery unit 30 through the power output port 16 of the at least one target battery pack and the at least one of the switch units 20 corresponding to the at least one target battery pack. Until the first voltage of the at least one target battery pack is less than or equal to the first predetermined voltage, the battery management unit 42 transmits the at least one blocking control signal to the cell monitor unit 12 of the at least one target battery pack. The cell monitor unit 12 of the at least one target battery pack controls the at least one of the switch units 20 corresponding to the at least one target battery pack to be turned off according to the at least one blocking control signal.

When the battery management unit 42 determines that the second voltage of the battery unit 30 is greater than or equal to the second predetermined voltage, the battery management unit 42 transmits the at least one blocking control signal to the cell monitor unit 12 of the at least one target battery pack. The cell monitor unit 12 of the at least one target battery pack controls the at least one of the switch units 20 corresponding to the at least one target battery pack to be turned off according to the at least one blocking control signal.

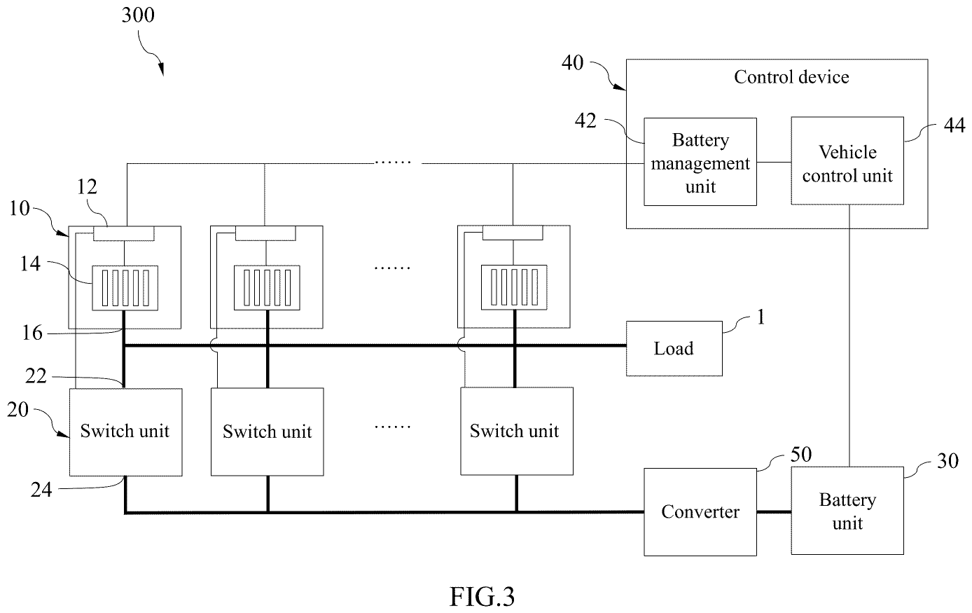

A power storage system 300 according to a third embodiment of the present invention is illustrated in FIG. 3. A structure of the power storage system 300 is almost identical to the structure of the power storage system 100, except that the power storage system 300 includes a converter 50. The converter 50 is electrically connected to the switch units 20 and the battery unit 30. When the at least one of the switch units 20 corresponding to the at least one target battery pack is turned on, the converter 50 converts the first voltage of the at least one target battery pack into a charging voltage and outputs the charging voltage to the battery unit 30. Until the first voltage of the at least one target battery pack is less than or equal to the first predetermined voltage, the battery management unit 42 transmits the at least one blocking control signal to the cell monitor unit 12 of the at least one target battery pack. The cell monitor unit 12 of the at least one target battery pack controls the at least one of the switch units 20 corresponding to the at least one target battery pack to be turned off according to the at least one blocking control signal. The charging voltage is less than the first voltage of the at least one target battery pack. In the current embodiment, the rated voltage of each of the battery packs 10 is greater than the rated voltage of the battery unit 30. For example, the rated voltage of each of the battery packs 10 is 48 V, and the rated voltage of the battery unit 30 is 24 V, but not limited thereto. In the current embodiment, the converter 50 could be a buck converter as an example.

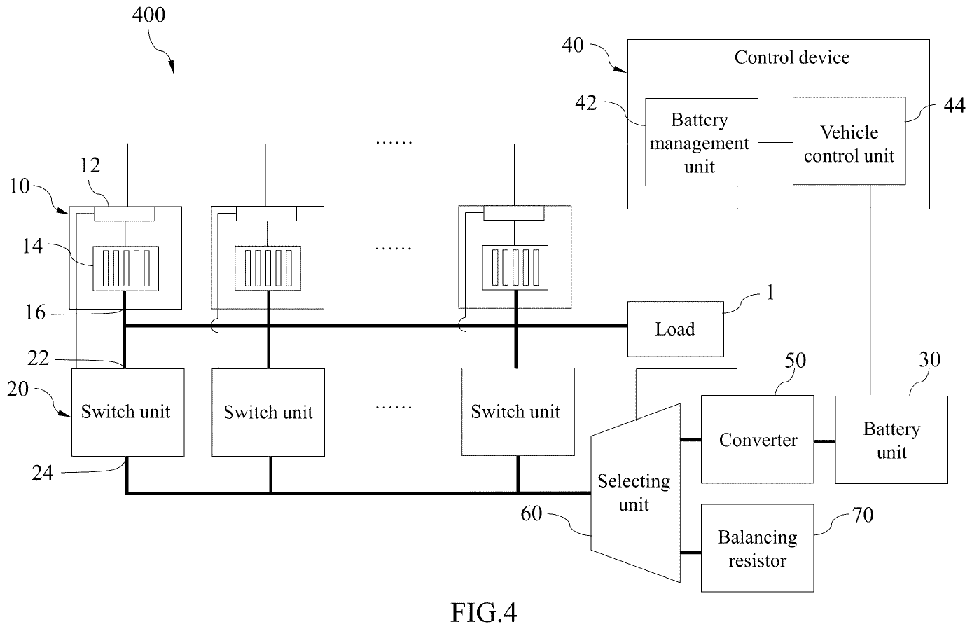

A power storage system 400 according to a fourth embodiment of the present invention is illustrated in FIG. 4. A structure of the power storage system 400 is almost identical to the structure of the power storage system 300, except that the power storage system 400 includes a balancing resistor 70 and a selecting unit 60. The selecting unit 60 is electrically connected to the balancing resistor 70, the switch units 20, the battery management unit 42, and the converter 50. When the battery management unit 42 determines that the first voltage of the at least one of the battery packs 10 is greater than the first predetermined voltage and the second voltage of the battery unit 30 is greater than or equal to the second predetermined voltage, the battery management unit 42 transmits the at least one conducting control signal to the cell monitor unit 12 of the at least one target battery pack. The cell monitor unit 12 of the at least one target battery pack controls the at least one of the switch units 20 corresponding to the at least one target battery pack to be turned on according to the at least one conducting control signal. The battery management unit 42 controls the selecting unit 60 to transmit the first voltage of the at least one target battery pack to the balancing resistor 70, thereby discharging the at least one target battery pack through the balancing resistor 70.

When the battery management unit 42 determines that the first voltage of the at least one of the battery packs 10 is greater than the first predetermined voltage and the second voltage of the battery unit 30 is less than the second predetermined voltage, the battery management unit 42 transmits the at least one conducting control signal to the cell monitor unit 12 of the at least one target battery pack. The cell monitor unit 12 of the at least one target battery pack controls the at least one of the switch units 20 corresponding to the at least one target battery pack to be turned on according to the at least one conducting control signal. The battery management unit 42 controls the selecting unit 60 to transmit the first voltage of the at least one target battery pack to the converter 50. The converter 50 converts the first voltage of the at least one target battery pack into the charging voltage and outputs the charging voltage to the battery unit 30. Until the first voltage of the at least one target battery pack is less than or equal to the first predetermined voltage, the battery management unit 42 transmits the at least one blocking control signal to the cell monitor unit 12 of the at least one target battery pack. The cell monitor unit 12 of the at least one target battery pack controls the at least one of the switch units 20 corresponding to the at least one target battery pack to be turned off according to the at least one blocking control signal.

Therefore, through the selecting unit 60 controlled by the battery management unit 42, the first voltage of the at least one target battery pack could be selectively transmitted to the battery unit 30 or the balancing resistor 70 after the battery management unit 42 determines that the first voltage of the at least one of the battery packs 10 is greater than the first predetermined voltage and determines if the second voltage is greater than the second predetermined voltage, thereby achieving the passive balancing.

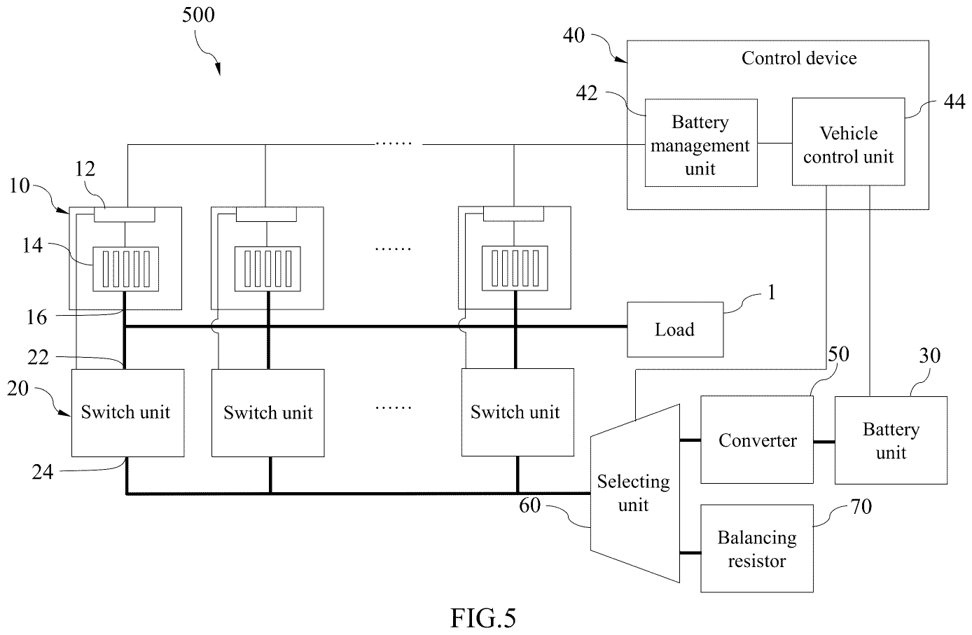

A power storage system 500 according to a fifth embodiment of the present invention is illustrated in FIG. 5. A structure of the power storage system 500 is almost identical to the structure of the power storage system 400, except that the selecting unit 60 is electrically connected to the vehicle control unit 44. When the battery management unit 42 determines that the first voltage of the at least one of the battery packs 10 is greater than the first predetermined voltage and the second voltage of the battery unit 30 is greater than or equal to the second predetermined voltage, the battery management unit 42 transmits the at least one conducting control signal to the cell monitor unit 12 of the at least one target battery pack. The cell monitor unit 12 of the at least one target battery pack controls the at least one of the switch units 20 corresponding to the at least one target battery pack to be turned on according to the at least one conducting control signal. The battery management unit 42 controls the selecting unit 60 to transmit the first voltage of the at least one target battery pack to the balancing resistor 70 through the vehicle control unit 44, thereby discharging the at least one target battery pack through the balancing resistor 70.

When the battery management unit 42 determines that the first voltage of the at least one of the battery packs 10 is greater than the first predetermined voltage and the second voltage of the battery unit 30 is less than the second predetermined voltage, the battery management unit 42 transmits the at least one conducting control signal to the cell monitor unit 12 of the at least one target battery pack. The cell monitor unit 12 of the at least one target battery pack controls the at least one of the switch units 20 corresponding to the at least one target battery pack to be turned on according to the at least one conducting control signal. The battery management unit 42 controls the selecting unit 60 to transmit the first voltage of the at least one target battery pack to the converter 50 through the vehicle control unit 44. The converter 50 converts the first voltage of the at least one target battery pack into the charging voltage and outputs the charging voltage to the battery unit 30. Until the first voltage of the at least one target battery pack is less than or equal to the first predetermined voltage, the battery management unit 42 transmits the at least one blocking control signal to the cell monitor unit 12 of the at least one target battery pack. The cell monitor unit 12 of the at least one target battery pack controls the at least one of the switch units 20 corresponding to the at least one target battery pack to be turned off according to the at least one blocking control signal.

Therefore, the first voltage of the at least one target battery pack could also be selectively transmitted to the battery unit 30 or the balancing resistor 70 to achieve the passive balancing through the selecting unit 60.

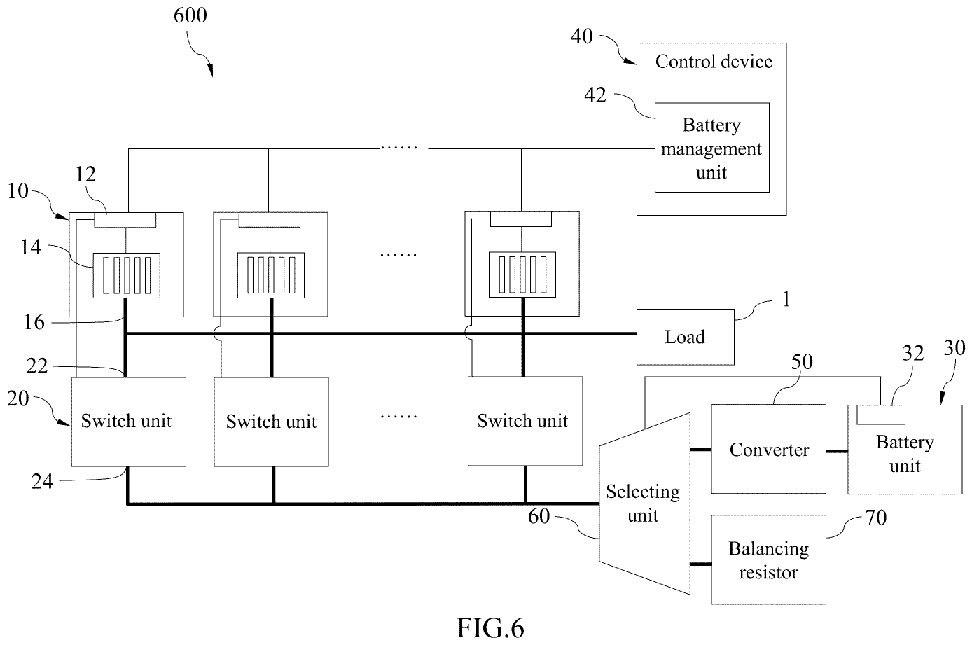

A power storage system 600 according to a sixth embodiment of the present invention is illustrated in FIG. 6. A structure of the power storage system 600 is almost identical to the structure of the power storage system 400, except that the control device 40 does not include the vehicle control unit 44 and the battery unit 30 includes an interior control unit 32. The interior control unit 32 is adapted to obtain the second voltage of the battery unit 30 and is electrically connected to the selecting unit 60. When the battery management unit 42 determines that the first voltage of the at least one of the battery packs 10 is greater than the first predetermined voltage and the interior control unit 32 determines that the second voltage of the battery unit 30 is greater than or equal to the second predetermined voltage, the battery management unit 42 transmits the at least one conducting control signal to the cell monitor unit 12 of the at least one target battery pack. The cell monitor unit 12 of the at least one target battery pack controls the at least one of the switch units 20 corresponding to the at least one target battery pack to be turned on according to the at least one conducting control signal. The interior control unit 32 controls the selecting unit 60 to transmit the first voltage of the at least one target battery pack to the balancing resistor 70, thereby discharging the at least one target battery pack through the balancing resistor 70.

When the battery management unit 42 determines that the first voltage of the at least one of the battery packs 10 is greater than the first predetermined voltage and the interior control unit 32 determines that the second voltage of the battery unit 30 is less than the second predetermined voltage, the battery management unit 42 transmits the at least one conducting control signal to the cell monitor unit 12 of the at least one target battery pack. The cell monitor unit 12 of the at least one target battery pack controls the at least one of the switch units 20 corresponding to the at least one target battery pack to be turned on according to the at least one conducting control signal. The interior control unit 32 controls the selecting unit 60 to transmit the first voltage of the at least one target battery pack to the converter 50. The converter 50 converts the first voltage of the at least one target battery pack into the charging voltage and outputs the charging voltage to the battery unit 30. Until the first voltage of the at least one target battery pack is less than or equal to the first predetermined voltage, the battery management unit 42 transmits the at least one blocking control signal to the cell monitor unit 12 of the at least one target battery pack. The cell monitor unit 12 of the at least one target battery pack controls the at least one of the switch units 20 corresponding to the at least one target battery pack to be turned off according to the at least one blocking control signal.

Therefore, the first voltage of the at least one target battery pack could also be selectively transmitted to the battery unit 30 or the balancing resistor 70 to achieve the passive balancing through the selecting unit 60.

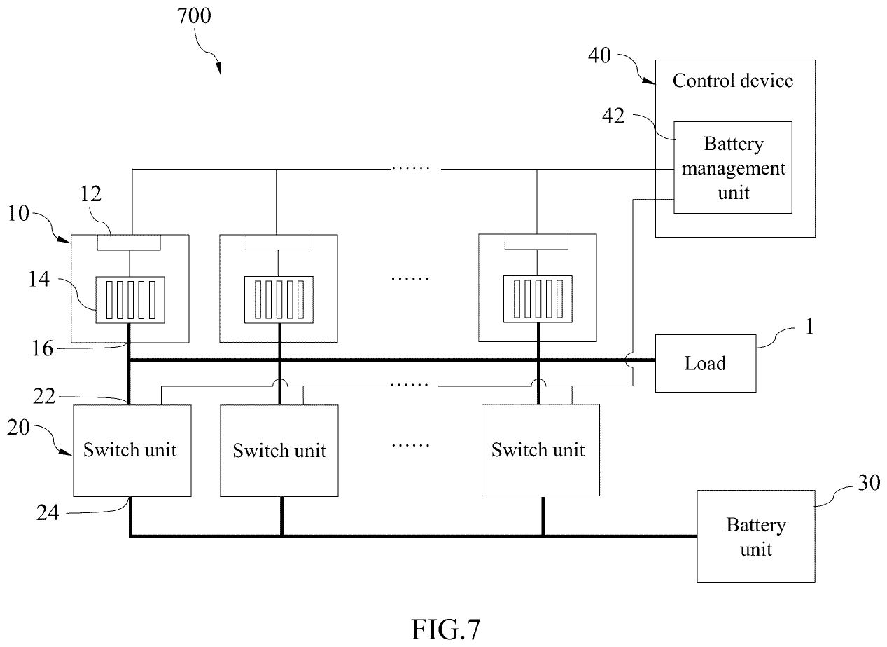

A power storage system 700 according to a seventh embodiment of the present invention is illustrated in FIG. 7. A structure of the power storage system 700 is almost identical to the structure of the power storage system 100, except that the battery management unit 42 is directly electrically connected to the switch units 20 instead of being indirectly electrically connected to the switch units 20 through the cell monitor units 12. When the battery management unit 42 determines that the first voltage of the at least one of the battery packs 10 is greater than the first predetermined voltage, the battery management unit 42 controls the at least one of the switch units 20 corresponding to the at least one target battery pack to be turned on, so that the at least one target battery pack outputs the first voltage of the at least one target battery pack to the battery unit 30. Until the first voltage of the at least one target battery pack is less than or equal to the first predetermined voltage, the battery management unit 42 controls the at least one of the switch units 20 corresponding to the at least one target battery pack to be turned off.

The configuration in which the battery management unit 42 of the seventh embodiment is directly electrically connected to the switch units 20 is likewise applicable to the second to sixth embodiments.

The power storage systems of the first to seventh embodiments described above could be implemented in conjunction with an active balancing and a passive balancing among a plurality of battery cells within each of the battery cell modules, as well as an active balancing among the battery packs. Therefore, the power of the power storage systems of the first to seventh embodiments could also be effectively utilized.

It must be pointed out that the embodiments described above are only some preferred embodiments of the present invention. All equivalent structures which employ the concepts disclosed in this specification and the appended claims should fall within the scope of the present invention.

What is claimed is:

1. A power storage system, comprising:
a plurality of battery packs, wherein each of the plurality of battery packs has a power output port;
a plurality of switch units, wherein each of the plurality of switch units has an input port and an output port; each of the plurality of switch units is controllable to conduct or block an electrical connection between each of the plurality of input ports and each of the plurality of output ports; the input port of each of the plurality of switch units is electrically connected to the power output port of each of the plurality of battery packs;
a battery unit electrically connected to the plurality of output ports of the plurality of switch units; and
a control device electrically connected to the plurality of battery packs and obtaining a first voltage of each of the plurality of battery packs from each of the plurality of battery packs; when the control device determines that the first voltage of at least one of the plurality of battery packs is greater than a first predetermined voltage, the at least one of the plurality of battery packs is defined as at least one target battery pack and the control device controls at least one of the plurality of switch units corresponding to the at least one target battery pack to be turned on; until the first voltage of the at least one target battery pack is less than or equal to the first predetermined voltage, the control device controls the at least one of the plurality of switch units corresponding to the at least one target battery pack to be turned off.

2. The power storage system as claimed in claim 1, wherein when the control device determines that the first voltage of each of the plurality of battery packs is greater than the first predetermined voltage, the plurality of battery packs are defined as a plurality of target battery packs; the control device controls each of the plurality of switch units corresponding to each of the plurality of target battery packs to be turned on.

3. The power storage system as claimed in claim 2, wherein when the first voltage of one of the plurality of target battery packs is less than or equal to the first predetermined voltage, the control device controls one of the plurality of switch units corresponding to one of the plurality of target battery packs to be turned off and then the control device controls another one of the plurality of switch units corresponding to another one of the plurality of target battery packs to be turned on.

4. The power storage system as claimed in claim 2, wherein the control device controls the plurality of switch units corresponding to the plurality of target battery packs to be turned on in a descending order of the plurality of first voltages of the plurality of target battery packs.

5. The power storage system as claimed in claim 2, wherein the control device controls the plurality of switch units corresponding to the plurality of target battery packs to be turned on in an ascending order of the plurality of first voltages of the plurality of target battery packs.

6. The power storage system as claimed in claim 1, wherein each of the plurality of battery packs comprises a cell monitor unit and a battery cell module; each of the plurality of cell monitor units is electrically connected to the control device and each of the plurality of battery cell modules; the control device obtains the first voltage of each of the plurality of battery cell modules through each of the plurality of cell monitor units; when the control device determines that the first voltage of the at least one of the plurality of battery packs is greater than the first predetermined voltage, the control device controls the at least one of the plurality of switch units corresponding to the at least one target battery pack to be turned on through the cell monitor unit of the at least one target battery pack; until the first voltage of the at least one target battery pack is less than or equal to the first predetermined voltage, the control device controls the at least one of the plurality of switch units corresponding to the at least one target battery pack to be turned off through the cell monitor unit of the at least one target battery pack.

7. The power storage system as claimed in claim 1, wherein each of the plurality of battery packs comprises a cell monitor unit and a battery cell module; the control device is electrically connected to the plurality of cell monitor units and the plurality of switch units; the control device obtains the first voltage of each of the plurality of battery packs from each of the plurality of battery packs through each of the plurality of cell monitor units.

8. The power storage system as claimed in claim 1, further comprising a converter, wherein the converter is electrically connected to the plurality of switch units and the battery unit; when the at least one of the plurality of switch units corresponding to the at least one target battery pack is turned on, the converter converts the first voltage of the at least one target battery pack into a charging voltage and outputs the charging voltage to the battery unit.

9. The power storage system as claimed in claim 1, further comprising a converter, a balancing resistor, and a selecting unit, wherein the converter is electrically connected to the battery unit; the selecting unit is electrically connected to the balancing resistor, the plurality of switch units, the control device, and the converter; the control device is electrically connected to the battery unit; the control device obtains a second voltage from the battery unit; when the control device determines that the first voltage of the at least one of the plurality of battery packs is greater than the first predetermined voltage and the second voltage of the battery unit is greater than or equal to a second predetermined voltage, the control device controls the selecting unit to transmit the first voltage of the at least one target battery pack to the balancing resistor; when the control device determines that the first voltage of the at least one of the plurality of battery packs is greater than the first predetermined voltage and the second voltage of the battery unit is less than the second predetermined voltage, the control device controls the selecting unit to transmit the first voltage of the at least one target battery pack to the converter; the converter converts the first voltage of the at least one target battery pack into a charging voltage and outputs the charging voltage to the battery unit.

10. The power storage system as claimed in claim 1, further comprising a converter, a balancing resistor, and a selecting unit, wherein the converter is electrically connected to the battery unit; the battery unit comprises an interior control unit; the selecting unit is electrically connected to the balancing resistor, the plurality of switch units, the interior control unit, and the converter; the interior control unit obtains a second voltage of the battery unit; when the control device determines that the first voltage of the at least one of the plurality of battery packs is greater than the first predetermined voltage and the interior control unit determines that the second voltage is greater than or equal to a second predetermined voltage, the interior control unit controls the selecting unit to transmit the first voltage of the at least one target battery pack to the balancing resistor; when the control device determines the first voltage of the at least one of the plurality of battery packs is greater than the first predetermined voltage and the interior control unit determines that the second voltage is less than the second predetermined voltage, the interior control unit controls the selecting unit to transmit the first voltage of the at least one target battery pack to the converter; the converter converts the first voltage of the at least one target battery pack into a charging voltage and outputs the charging voltage to the battery unit.
